(19) United States
(12) Patent Application Publication
(10) Pub. No.: US 2008/0313208 A1
(43) Pub. Date: Dec. 18, 2008

(54) APPARATUS, SYSTEM, AND METHOD FOR AUTOMATED CONTEXT-SENSITIVE MESSAGE ORGANIZATION

(75) Inventors: Andrew G. Hourselt, Tucson, AZ (US); Siou Lin, Tucson, AZ (US); Michael R. Maletich, Tucson, AZ (US); Richard A. Welp, Tucson, AZ (US)

Correspondence Address: Kunzler & McKenzie, 8 EAST BROADWAY, SUITE 600, SALT LAKE CITY, UT, 84111, US

(73) Assignee: International Business Machines Corporation, Armonk, NY (US)

(21) Appl. No.: 11/763,344

(22) Filed: Jun. 14, 2007

(51) Int. Cl. G06F 17/30

(52) U.S. Cl. 707/102; 707/E17.01

(57) ABSTRACT

A method and system are disclosed for automated context-sensitive message organization. The method in the disclosed embodiments substantially includes determining a logical correlation between a message identifier and a message file. The method may also include scanning a source code file to identify a reference to the message identifier and the associated context of the reference. In a further embodiment, the method includes analyzing source code file and message file based on a context of the identified reference in accordance with a predetermined analysis rule. Additionally, the method may include generating an output based on a result of the analysis.

### BACKGROUND OF THE INVENTION

1. Field of the Invention

This invention relates to application message organization and more particularly relates to automated context-sensitive message organization.

2. Description of the Related Art

In a global economy, user-viewable text for an application often needs to be translated to several languages. For example, a word processing application may include drop-down menus, pop-up messages, and status identifiers that display text. Before the application is sold in a market, the user-viewable text is typically translated into the language of that market. It would be difficult to go through the source code of the application and manually translate and modify every reference to a user-viewable message.

One means of streamlining the translation process includes assigning a unique identifier to each user-viewable message and consolidating these identifier-message mappings in a common message file. When a message needs to be displayed, its respective identifier is passed into a function, which translates the message to a specified language. The advantage of keeping all user-viewable messages in a common file is that it facilitates the translation of these messages to other languages. One drawback of this methodology is that applications are typically developed by a team of programmers, it is difficult to maintain a consistent organization of a common message file as each programmer adds or removes his or her own identifier-message mappings.

In a large application, there can be thousands of user-viewable messages. Moreover, at the end of a development cycle, an application will typically contain large numbers of messages that require revision because they use inconsistent terminology or are not grammatically correct. Before the release of an application, reviewers and translators must approve and translate all the user-viewable messages.

Due to the team development process, common message files often contain numerous messages that are no longer referenced, duplicated, and not organized by context. Additionally, the application source code may include invalid references to message identifiers that have been deleted from a common message file. In order to facilitate the review and translation process, common message files should be organized in a manner that is easy for reviewers and translators to process. However, it is an arduous task to manually organize a common message file.

In some cases it is necessary to assign contiguous message identifiers to all messages associated with a particular drop-down menu so that a reviewer can quickly scan the messages related to the menu for inconsistent terminology. Assigning a message a new identifier involves manually searching the entire application code, manually finding any references to the previous identifier, manually updating each reference to use the new identifier, recompiling the entire application, and manually verifying that the application is still in working order. Moreover, accidentally duplicating or deleting an identifier could result in serious, difficult-to-track bugs in the application.

Indeed, due to the large number of messages in a typical application, it may be difficult or even impossible to manually analyze and reorganize all the identifier-message mappings according to context. Automated contextual reorganization of messages may help streamline the application code, and the translation process. However, typical message organization schemes and processes do not consider the context of the message references.

### SUMMARY OF THE INVENTION

From the foregoing discussion, it should be apparent that a need exists for a method and system that perform automated context-sensitive message organization.

The present invention has been developed in response to the present state of the art, and in particular, in response to the problems and needs in the art that have not yet been fully solved by currently available application development environments. Accordingly, the present invention has been developed to provide an apparatus, system, and method for automated context-sensitive message organization that overcomes many or all of the above-discussed shortcomings in the art.

A method of the present invention is presented for automated context-sensitive message organization. The method in the disclosed embodiments substantially includes determining a logical correlation between a message identifier and a message file. The method may also include scanning a source code file to identify a reference to the message identifier and the associated context of the reference. In a further embodiment, the method includes analyzing source code file and message file based on a context of the identified reference in accordance with a predetermined analysis rule. Additionally, the method may include generating an output based on a result of the analysis.

In a further embodiment, the method generates a data structure comprising the message file and an associated message identifier. The method may also include recording auxiliary information for the identified reference, including a name of the source code file in which the identified reference was identified, a line number corresponding to the location of the identified reference within the source code file, a component identifier for identifying an application component with which the identified reference is associated, and an object type of an insert parameter associated with the identified reference.

In one embodiment, the source code file and message file are analyzed in response to a file context, a component context, and/or an object context associated with the identified reference. In a further embodiment, the source code file and message file are analyzed in response to at least one of the following rules: (a) an unreferenced message elimination rule, (b) a duplicate message elimination rule, (c) a context-sensitive message organization rule, (d) a comment generation rule, (e) a message reference update rule, (f) a message consolidation rule, (g) a message consistency rule, (h) a message grammar error detection rule, (i) a message organization error detection rule, (j) an illegal wording detection rule, (k) a phantom message detection rule, and (l) a statistic determination rule.

The method may also include generating an analysis log in response to the result of the analysis. The analysis log comprises of at least one of a record of an analysis step, a translation cost statistic, a record of the identified reference, a record of auxiliary information associated with the identified reference, and a message to a user. The method may also include generating a filtered message file in response to the result of the analysis. In a further embodiment, the method updates the source code file in response to the result of the analysis.

A system is presented for automated context-sensitive message organization. In one embodiment, the system includes an application development server configured to host an Integrated Development Environment (IDE) application. Additionally, the system may include a storage volume coupled to the application development server, and configured to store one or more source code files and one or more message files.

The system may further include a message organizer in communication with the application development server. The message organizer may include a determination module, a scanner module in communication with the determination module, an analyzer module in communication with the scanner module, and an output module in communication with the analyzer module. The determination module may read a message file from the storage volume, and determine a logical correlation between a message identifier and the message file. The scanner module may scan a selected portion of a source code file to identify a reference to the message identifier and the associated context of the reference. Further, the analyzer module may analyze source code file and message file based on a context of the identified reference in accordance with a predetermined analysis rule. In a further embodiment, the output module may generate an output based on a result of the analysis.

A computer program product is also presented for automated context-sensitive message organization. In one embodiment, the computer program product includes a computer readable medium having computer usable program code executable to perform operations substantially necessary to carry out the steps of the method described above.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system for automated context-sensitive message organization;

FIG. 2 is a schematic block diagram illustrating one embodiment of a message organizer configured for automated context-sensitive message organization;

FIG. 3 is a detailed schematic block diagram illustrating another embodiment of a message organizer configured for automated context-sensitive message organization;

FIG. 4 is a schematic flow chart diagram illustrating one embodiment of a method for automated context-sensitive message organization; and

FIG. 5 is a detailed schematic flow chart diagram illustrating one embodiment of a method for automated context-sensitive message.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a signal bearing medium may take any form capable of generating a signal, causing a signal to be generated, or causing execution of a program of machine-readable instructions on a digital processing apparatus. A signal bearing medium may be embodied by a transmission line, a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

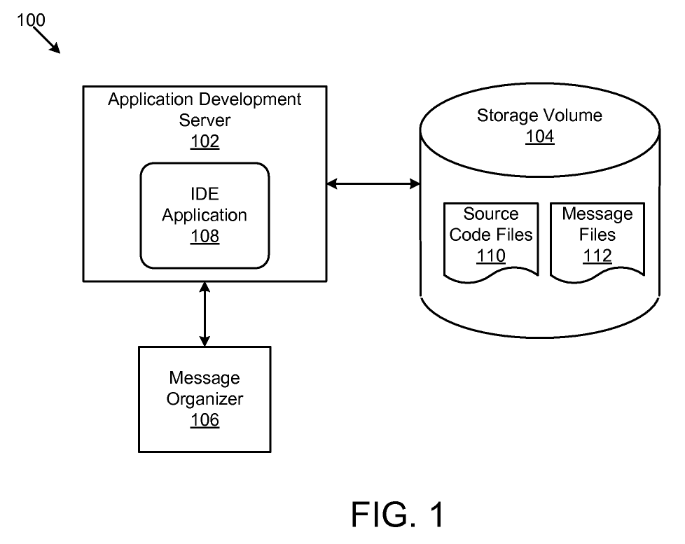

FIG. 1 depicts one embodiment of a system 100 for automated context-sensitive message organization. The system 100 may include an application development server 102, a storage volume 104, and a message organizer 106. The application development server 102 may host an IDE application 108 which is configured to facilitate an application developer in generating and referencing application source code files 110 and application message files 112. The source code files 110 and the message files 112 may be stored on the storage volume 104. The message organizer 106 may automatically organize message files 112 and references to the message files 112 within the source code files 110. Additionally, the message organizer 106 may generate logs and statistics for translation cost estimation, message commenting, operational results reporting, and the like.

In one embodiment, the application development server 102 includes an enterprise application server, such as those available from International Business Machines, Inc. (IBM®). Alternatively, the application development server 102 may include a laptop, a desktop workstation, or other processing devices suitable for application development. In one embodiment, the storage volume may be peripherally coupled to the application development server 102. Alternatively, the storage volume 104 may be internally coupled to the application development server 102. In one embodiment, the message organizer 106 may include a hardware component peripherally coupled to the application development server 102. Alternatively, the message organizer 106 may be internally coupled, or in communication with the application development server 102. In a further embodiment, the message organizer 106 may include a computer program product comprising computer readable code that is executable by a processor of the application development server 102.

As discussed above, the application development server 102 may host an IDE application 108. The IDE application 108 may facilitate development of application source code files 110 and message files 112. Additionally, the IDE application 108 may facilitate application code organization, debugging, translation, and compiling. Specifically, the IDE application 108 may be configured to provide a developer-interactive environment for the development of internationally marketable applications. In such an embodiment, the IDE application 108 may include software modules or components configured to facilitate translation of user-viewable text and messages into a plurality of languages. Additionally, the IDE application 108 may provide a framework for organizing source code files 110 and message files 112.

Specifically, the IDE application 108 may include Input/Output (I/O) commands configured to control I/O ports of the application development server 102. The I/O commands may enable the IDE application to access source code files 110 and message files 112 stored on the storage volume 104. In a further embodiment, the IDE application 108 may include logical level commands configured to organize and group source code files 110 and message files 112 on the storage volume 104. In certain embodiments, the IDE application 108 may include a Graphical User Interface (GUI), which enables an application developer to view and interact with an application organization chart or tree, application source code files 110, the text of the message files 112, and certain debug, development, and compiling controls and interfaces.

The storage volume 104 may include a hard disk, a Random Access Memory (RAM) storage device, a flash memory device, an optical storage device, or other suitable storage means. In one embodiment, the storage volume 104 may be a hard disk mounted within and powered by the application development server 102. In such an embodiment, the storage volume 104 may be coupled to the application development server 102 physically. Additionally, the storage volume 104 may be in data communication with the application development server 102 via a data bus. The storage volume 104 may store source code files 110 and message files 112 associated with an application developed with the IDE application 108. The source code files 110 and the message files 112 may be physically or logically arranged into groups. For instance, the message files 112 may be grouped on a single segment, or group of contiguous segments of the storage volume 104. Alternatively, the source code files 110 and the message files 112 may be logically grouped through location maps stored on the application development server 102, but physically spread across the storage volume 104, or a group of storage volumes 104.

The message organizer 106 may automatically organize application message files 112 and source code files 110. Specifically, the message organizer 106 may streamline a message translation process by organizing, consolidating, and simplifying the message files 112, the references to the message files 112 within the source code files 110, and the mapping between the message files 112 and message identifier used for referencing the message files 112 in the source code files 110. In a specific embodiment, the message organizer 106 may analyze and organize the source code files 110 and the message files 112 based on the context of the message references within the source code files 110, and in response to one or more rules. A user may dynamically define the rules, or alternatively, the rules may be statically defined in a database of predetermined rules.

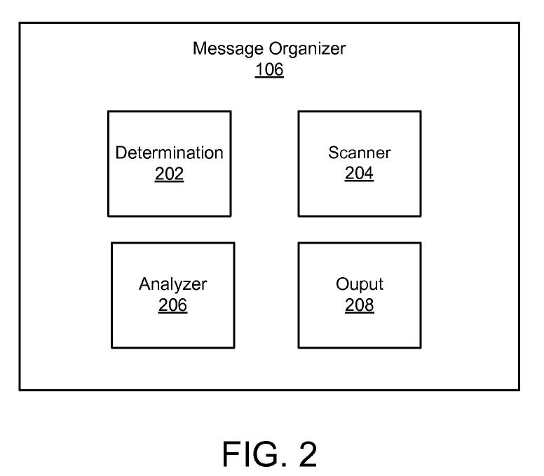

FIG. 2 illustrates a further embodiment of the message organizer 106. In the depicted embodiment, the message organizer 106 includes a determination module 202, a scanner module 204, an analyzer module 206, and an output module 208. In one embodiment, the message organizer 106 may include a stand-alone hardware device in communication with the application development server 102. Alternatively, the message organizer 106 may be implemented in software and integrated with the IDE application 108.

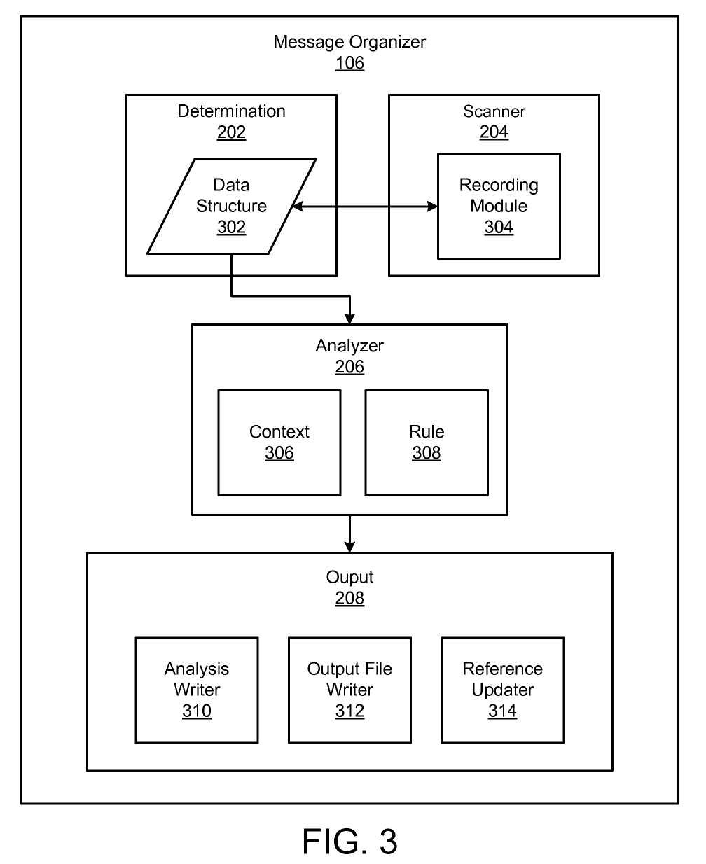

The determination module 202 may read message files 112 from the storage volume 104, and determine a mapping, or logical correlation, between the message files 112 and message identifiers associated with the message files 112. A message identifier may include a string-based call to the message file 112. In certain embodiments, the call may include one or more parameters. A slightly different view of the message identifier may include a statically or dynamically assigned pointer to the location of the message file 112 on the storage volume 104. In either case, the message identifier includes a way for the source code files 110 to reference the message files 112 to produce user-viewable text for the application. As discussed in further detail with reference to FIG. 3 below, a message identifier may be mapped to a message file 112.

The scanner module 204 may communicate with the determination module 202. For example, the scanner module 204 may be physically coupled to the determination module 202, or alternatively, the scanner module 204 may exchange data through interactions with the processor of the application development server 102. In one embodiment, the scanner module 204 may access lines of the application code file 110 and scan the lines for references to the message files 112. For example, the scanner module 204 may parse through lines of code identifying references comprising message identifiers. In one embodiment, the scanner module 204 may read in a line of code as a string. The scanner module 204 may then compare the text within the string with identified message identifiers to identify references to message files 112.

An exemplary embodiment the character string “Display (“MSG1”, getDate( ))” may comprise a reference to a message file 112 from a source code file 110. In this example, the display command indicates how the message will be presented to an application user. The “MSG1” term is an example of a message identifier. The “getDate( )” command dynamically retrieves a date. In this example, the scanner module 204 may identify the reference to MSG1. The scanner module 204 may then identify the context of the reference by identifying the reference as a “Display( )” command and by identifying that an associated insert will be a value with a data type of “Date” returned from the “getDate( )” function. An associated excerpt from a message file 112 may include, for example, “MSG1 “Hello, today's date is {0}.” In this example, “MSG1” is the message identifier, “Hello, today's date is” is user-viewable text, and “{0}” indicates an insert from a separate function called by the reference in the source code file 110, or the getDate( ) function in this case.

Although the above exemplary embodiment is introduced for purposes of clarification, the specific syntax and language platform indicated in the example are not intended to limit the scope of the claims. One of ordinary skill in the art of application development will recognize that the present invention may be implemented with various application language platforms and syntax structure. For example, the present invention may organize references to message files 112 for applications written in JAVA, C, C++, C#, .NET, HTML, BASIC, and other application coding languages and in various application development environments including Microsoft Visual Studio®, and the like.

The analyzer module 206 may analyze one or more source code files 110 and one or more message files 112 based on a context 306 of the identified reference and in accordance with a predetermined analysis rule 308. Specific embodiments of the context 306 and the analysis rule 308 are discussed in greater detail with reference to FIG. 3 below. The analyzer module 206 may compare references to the message identifiers in the source codes 110 and user-viewable text comprising the message files 112 using a comparison function and one or more data structures to contain information about the references and the user-viewable text. In a specific embodiment, the determination module 202 may generate a data structure 302 from the message identifiers and the message files 112. The analyzer module 206 may compare identified references to the message identifier within the source code 110 with information stored in the data structure 302 using a comparison function. In a further embodiment, the analyzer module 206 may calculate statistics that assist the application developer in estimating translation costs. Further embodiments of the analyzer module 206 are discussed below with reference to FIG. 3.

The output module 208 may generate an output based on a result of the analysis performed by the analyzer module 206. In one embodiment, the output module 208 may update message files 112 and source code files 110. In a further embodiment, the output module 208 may generate new message files 112 and/or source code files 110. Additionally, the output module 208 may generate log files, reports, user-viewable messages, and the like for communicating information regarding the organization process to the application developer.

FIG. 3 illustrates a further embodiment of the message organizer 106. This embodiment includes the determination module 202, the scanner module 204, the analyzer module 206, and the output module 208 substantially as described above with relation to FIG. 2. Additionally, the determination module 202 may generate a data structure 302 for mapping the message identifiers and the message files 112. The scanner module 204 may also include a recording module 304 for collecting auxiliary information associated with references to the message identifiers within the source code files 110. The analyzer module 206 may further base the analysis on the context 306 of references to the message identifiers within the source code files 110, and one or more predetermined rules 308. In a further embodiment, the output module 208 includes an analysis writer 310, an output file writer 312, and a reference updater 314 as described below.

The data structure 302 may include the message file 112, or text from the message file 112, and an associated message identifier. In one embodiment, the data structure may include a data hash table, a multidimensional array, a dynamically allocated array, an associated database, or another form of data construct. In a further embodiment, the data structure 302 may include auxiliary information associated with references to the message identifier.

The recording module 304 may record the auxiliary information for the identified reference. In one embodiment, the auxiliary information may include the name of the source code file 110 in which the identified reference was identified. Additionally, the auxiliary information may include the line number corresponding to the location of the identified reference within the source code file 110. The auxiliary information may further include a component identifier for identifying an application component with which the identified reference is associated. This component identifier may provide component level context 306 for the analyzer module 206 as discussed below. In a further embodiment, the auxiliary information may include the object type of an insert parameter associated with the identified reference. For example, if the source code file 110 is written in an object oriented coding platform, such as JAVA, the object type may include an indication that the message file 112 is a JAVA bean, or other JAVA object type. Alternatively, in a class oriented platform, such as C and C++, the object type may include the class identifier or a data type for a function associated with the message file 112.

In one embodiment, context-sensitive message organization may include consideration of a file context 306, a component context 306, and an object context 306 when determining an appropriate organization for message files 112 and references to message files within the source code files 110.

A file context 306 may involve consideration of groupings of message identifiers within a single source code file 110, or group of source code files 110. In a further embodiment, the organization and grouping of message files 112 may be considered as part of the file context 306 of references. For example, the message organizer 106 may identify all the references to message identifiers within a specified source code file 110. The message organizer may then group corresponding message files 112 into a single directory associated with the source code file 110. Additionally, the message organizer may record the number of references within the file for translation cost statistics, and record the location of references within the source code file 110 or generate comments associated with the source code file 110 to facilitate translation of the messages and other application development tasks.

In a further embodiment, the object organizer 106 may consider object context in organization of message files 112 and references to message identifiers within source code files 110. Specifically, the object context 306 may include a determination of the type of object associated with an insert. As discussed above, certain references to message identifiers may include an associated variable data insert. The object context 306 may involve a determination of the data type or object type of the insert associated with the identified reference. In a further embodiment, the message organizer 106 may generate comments to the source code file 110 describing the inserts to aid in translation and other application development tasks. For example, the message organizer 106 may insert a comment describing an insert associated with an identified reference to a message identifier as a “date” type object, or the like.

In another embodiment, the message organizer 106 may include a consideration of a component context when organizing message references and message files 112. For example, text associated with a drop down menu may originally be stored in separate message files 112. The message organizer 106 may consider the component context by determining that a group of references to message identifiers are all associated with the same drop down menu or other component. In such an embodiment, the message organizer 106 may group the message files 112 associated with the identified references into a single message file 112 to simplify translation and other application development tasks. In a further embodiment, the message organizer 106 may add comments to the source code files 110 identifying and explaining actions involving component context 306.

The rule 308 may include one or more of the following rules 308: (a) an unreferenced message elimination rule 308, (b) a duplicate message elimination rule 308, (c) a context-sensitive message organization rule 308, (d) a comment generation rule 308, (e) a message reference update rule 308, (f) a message consolidation rule 308, (g) a message consistency rule 308, (h) a message grammar error detection rule 308, (i) a message organization error detection rule 308, (j) an illegal wording detection rule 308, (k) a phantom message detection rule 308, and (l) a statistic determination rule 308. Although these rules 308 are explicitly listed as examples, this list is not intended to be inclusive of all possible rules 308 that may be referenced by the analyzer 206 or by the message organizer 106 generally. One of ordinary skill in the art will recognize that additional and alternative rules 308 may be contemplated and implemented as part of the analysis performed by the analyzer 206. These messages are listed merely to illustrate the flexibility of the message organizer 106, not to limit the number of rules 308 that may be implemented by the message organizer 106.

The following is a brief description of each of the rules 308 identified above. Alternative rules 308, and alternative embodiments of the identified rules 308 may exist and may be implemented with the message organizer 106 by one of ordinary skill in the art. These rules 308 may be implemented by the analyzer module 206 when causing the message organizer 106 to perform an automated message organization task. The (a) unreferenced message elimination rule 308 may involve identifying and eliminating message files 112 that are no longer referenced by the source code files 110. The (b) duplicate message elimination rule 308 may identify and eliminate common messages that appear several times in a source code file 110.

For example, the messages “OK” and “Cancel” may be referenced several times within the source code files 110. If separate message files 112 exist for these messages, the message files 112 may be consolidated into a single “OK” or “Cancel” message file 112. The (c) context-sensitive message organization rule 308 may group messages based on the source code files 110 or components that the message files 112 are associated with through references to the message identifiers. The (d) comment generation rule 308 may generate comments to clarify the context of a message. For example, comments may be generated in the message file 112 to identify the source code files 110 that reference the message file 112. The (e) message reference update rule 308 may update references to the message identifiers throughout the source code files 110 for clarification or consistency. For example, if a message identifier is changed, references to the old message identifier may be updated automatically throughout the source code files 110. The (f) message consolidation rule 308 may include identification and consolidation of repetitive message files 112, or of similar references to message files 112 within the source code files 110. The (g) message consistency rule 308 may identify similar messages within the message files, and consolidate or update the messages for consistency. For example, a message “Pay here” may be consolidated with a separate message “Pay Here.” The (h) message grammar error detection rule 308 may scan the text of the message files 112 to identify spelling or grammar errors. The (i) message organization error detection rule 308 may detect text that has been categorized in the wrong common message file.

For example if the developer specifies a rule 308 that message text and label text are to be stored in separate message files 112, this rule 308 may cause the message organizer 106 to identify label text inadvertently stored with message text and rectify the problem. The (j) illegal wording detection rule 308 may identify and correct phrases that are deemed illegal by the developer or by a development standard. For example, the words “Please” and “Thank you” are generally regarded as inappropriate messages by application developers. The (k) phantom message detection rule 308 may cause the message organizer 106 to identify messages that are referenced within the application source code files 110, but that the corresponding message file 112 has been inadvertently deleted. The (l) statistic determination rule 308 may cause the analyzer 206 to identify and calculate statistics to present to an application developer or user. For example, a translation cost statistic may be generated by computing the number or message files 112, and the number of references to message identifiers within the source code files 110 exist. As discussed above, alternative embodiments of these rules 308 may exist, and additional and/or alternative rules 308 may be implemented by the analyzer module 206.

In one embodiment, the analysis writer 310 is configured to generate an analysis log in response to the result of the analysis performed by the analyzer module 206. The analysis log may include a record of analysis steps performed by the analyzer module 206. In a further embodiment, the log may include a translation cost statistic generated by the analyzer module 206. The log may also include a record of the message reference identified by the scanner module 204. The log may also include a record of the auxiliary information associated with the identified reference. In an alternative embodiment, the analysis writer 310 may display a message to a user of the message organizer 106, such as an application developer.

In a further embodiment, the output file writer 312 may generate a filtered message file 112 in response to the result of the analysis performed by the analyzer module 206. For example, if a (c) ) context-sensitive message organization rule 308 is applied by the analyzer module 206 and the file context 306 is selected, the analyzer module 206 may generate an updated logical organization of message files 112 and source code files 110 based on the file context. The output file writer 312 may then write the message files 112 and source code files 110 to the appropriate directories. In an alternative embodiment, if a (d) comment generation rule 308 is applied, the analyzer module 206 may generate a list of comments to be added to the source code files 110 and/or the message files 112. The output file writer 312 may then write updated message files 112 and source code files 110 that include the comments specified by the analyzer module 206.

The reference updater 314 may update the source code file 110 in response to the result of the analysis performed by the analyzer module 206. For example, if an (f) message consolidation rule 308 is applied by the analyzer module 206, the reference updater 314 may parse through the source code files 110 and update or modify the references to message identifiers for consistency and consolidation. Specifically, references to duplicative message files 112 may be modified to point to a single consolidated message file. Alternatively, of the component context 306 is considered, separate references to menu text may be updated to point to a single consolidated message file 112 associated with the component.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

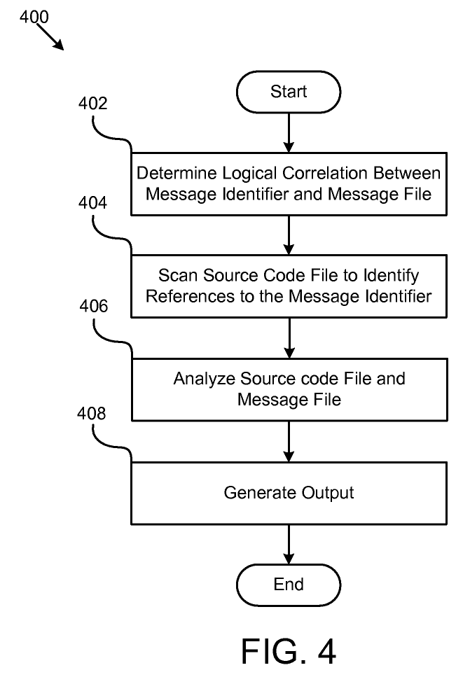

FIG. 4 illustrates one embodiment of a method 400 for context-sensitive automated message organization. Specifically, the method starts when the determination module 202 determines 402 a logical correlation between message identifiers and message files 112. In one embodiment, this correlation may include a mapping of pointers to message files 112, the mapping stored in a data structure 302. The scanner module 204 may then scan 404 a selected portion of a source code file 110 or group of source code files 110 to identify references to the message identifiers within the source code files 110. In one embodiment, the identified references and corresponding auxiliary information may be stored. The analyzer module 406 may then analyze the source code files 110 and message files 112 based on identified context 306 and rules 308. The output module 208 may then generate one or more output files and/or updated files 110, 112 based on the results of the analysis 406 performed by the analyzer module 206.

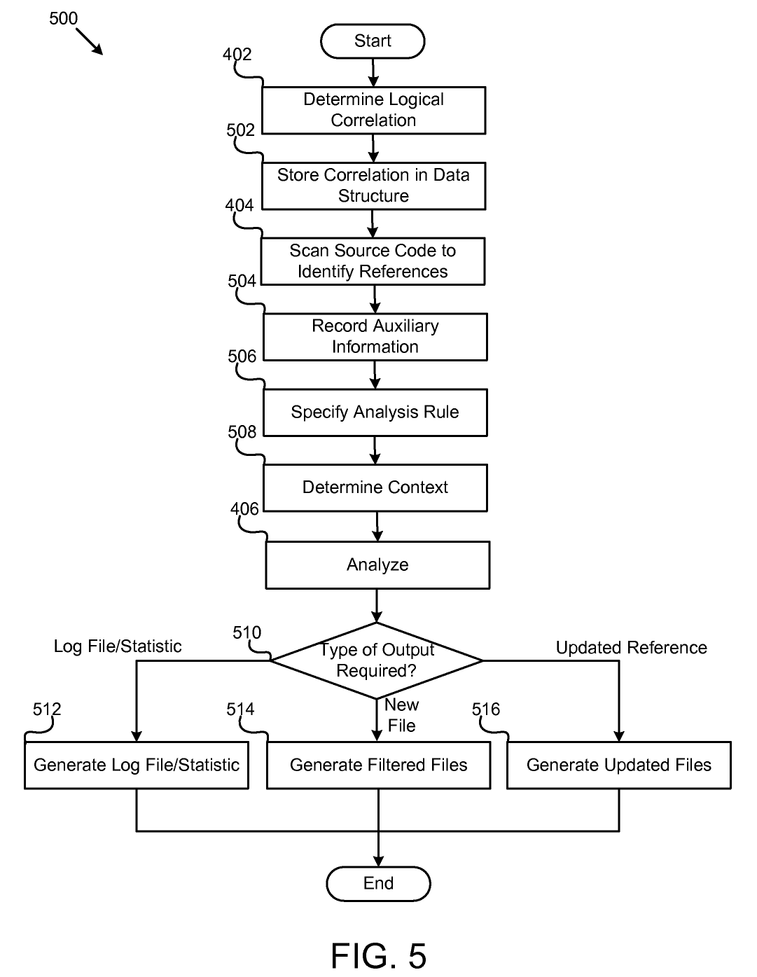

FIG. 5 illustrates an alternative embodiment of a method 500 for automated context-sensitive message organization. In one embodiment, the method 500 starts when the determination module 202 determines 402 a logical correlation between message identifiers and message files 112. This determination 402 may be performed in substantially the same way as described with relation to FIG. 4 above. In a further embodiment, the determination 202 may store 502 the mapping of message identifiers to message files 112 in a data structure 302. For example, the determination module 202 may dynamically generate a multidimensional array comprising message identifiers and strings of text from message files 112.

The scanner module 204 may then scan 404 a source code file 110 to identify references to message identifiers in substantially the same manner as described above. In a further embodiment, the scanner module 204 may also identify context-specific auxiliary information and the recording module 304 may record 504 the auxiliary information. In a specific embodiment, the recording module 304 may record 504 the auxiliary information in association with the data structure 302. For example, the recording module 304 may add auxiliary information to the data structure dynamically.

The analyzer module 406 may then analyze 406 the source code files 110 and the message files 112 as described above. In a further embodiment, one or more analysis rules 308 may be specified 506 and the analyzer module 206 may analyze 406 the source files based on the specified rules 506 and a context 306 determined either by a user, or by the references themselves. For example, the nature of the references, including the grouping, location, and associated components or objects may determine the context 306 of the references.

Once the analyzer module 206 has analyzed the files 110, 112, the output module 208 may determine 510 the type of output to generate 512,514,516. For example, if the output module 208 determines 510 that a log file or statistic should be generated 512, the analysis writer 310 may write a log file or statistic to a file for an application developer, or user to access. Alternatively, if the output module 208 determines 510 that filtered message files 112 or source code files 110 should be generated 514, the output file writer 312 may generate 514 the filtered files 110, 112. In another embodiment, if the output module 208 determines 310 that references to message identifiers within the source code files 110 should be updated, the reference updater 314 may generate 516 updated source code files 110 that include the updated references. In various embodiments, these output files may be generated 512, 514, 516 in conjunction or in the alternative. For example, the analysis writer 310 may generate 512 a log file, and the reference updater 314 may generate 516 updated source code files 516, but the output file writer 312 may not generate filtered source code files 110 or message files 112. Various combinations may exist based on the requirements of the analyzer module 206.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for automated context-sensitive message organization, the method: comprising:
determining a logical correlation between a message identifier and a message file;
scanning a source code file to identify a reference to the message identifier and the associated context of the reference;
analyzing source code file and message file based on a context of the identified reference in accordance with a predetermined analysis rule; and
generating an output based on a result of the analysis.

2. The method of claim 1, further comprising generating a data structure comprising the message file and an associated message identifier.

3. The method of claim 1, wherein the source code file and message file are analyzed in response to:
at least one of a file context, a component context, and an object context associated with the identified reference; and
at least one rule selected from the group of rules comprising an unreferenced message elimination rule, a duplicate message elimination rule, a context-sensitive message organization rule, a comment generation rule, a message reference update rule, a message consolidation rule, a message consistency rule, a message grammar error detection rule, a message organization error detection rule, an illegal wording detection rule, a phantom message detection rule, and a statistic determination rule.

4. The method of claim 1, further comprising recording auxiliary information for the identified reference, the auxiliary information comprising at least one of:
a name of the source code file in which the identified reference was identified;
a line number corresponding to the location of the identified reference within the source code file;
a component identifier for identifying an application component with which the identified reference is associated; and
an object type of an insert parameter associated with the identified reference.

5. The method of claim 4, further comprising generating an analysis log in response to the result of the analysis, the analysis log comprising at least one of a record of an analysis step, a translation cost statistic, a record of the identified reference, a record of auxiliary information associated with the identified reference, and a message to a user.

6. The method of claim 1, further comprising generating a filtered message file in response to the result of the analysis.

7. The method of claim 1, further comprising updating the source code file in response to the result of the analysis.

8. A system for automated context-sensitive message organization, the system comprising:
an application development server configured to host an Integrated Development Environment (IDE) application;
a storage volume coupled to the application development server, and configured to store one or more source code files and one or more message files; and
a message organizer in communication with the application development server comprising;
a determination module configured to read a message file from the storage volume, and determine a logical correlation between a message identifier and the message file;
a scanner module in communication with the determination module, the scanner module configured to scan a selected portion of a source code file to identify a reference to the message identifier and the associated context of the reference;
an analyzer module in communication with the scanner module, wherein the analyzer module is configured to analyze source code file and message file based on a context of the identified reference in accordance with a predetermined analysis rule; and
an output module in communication with the analyzer module, wherein the output module is configured to generate an output based on a result of the analysis.

9. The system of claim 8, wherein the analyzer module is further configured to analyze the source code file and message file in response to:
at least one of a file context, a component context, and an object context associated with the identified reference; and
at least one rule selected from the group of rules comprising an unreferenced message elimination rule, a duplicate message elimination rule, a context-sensitive message organization rule, a comment generation rule, a message reference update rule, a message consolidation rule, a message consistency rule, a message grammar error detection rule, a message organization error detection rule, an illegal wording detection rule, a phantom message detection rule, and a statistic determination rule.

10. The system of claim 8, wherein the scanning module further comprises a recording module configured to record auxiliary information for the identified reference, the auxiliary information comprising at least one of:
a name of the source code file in which the identified reference was identified;
a line number corresponding to the location of the identified reference within the source code file;
a component identifier for identifying an application component with which the identified reference is associated; and
an object type of an insert parameter associated with the identified reference.

11. The system of claim 10, wherein the output module further comprises an output analysis writer configured to generate an analysis log in response to the result of the analysis, the analysis log comprising at least one of a record of an analysis step, a translation cost statistic, a record of the identified reference, a record of auxiliary information associated with the identified reference, and a message to a user.

12. The system of claim 8, wherein the output module further comprises an output file writer configured to generate a filtered message file in response to the result of the analysis.

13. The system of claim 8, wherein the output module further comprises a reference updater configured to update the source code file in response to the result of the analysis.

14. A computer program product comprising a computer readable medium having computer usable program code executable to perform operations for automated context-sensitive message organization, the operations of the computer program product comprising:
determining a logical correlation between a message identifier and a message file;
scanning a source code file to identify a reference to the message identifier and the associated context of the reference;
analyzing source code file and message file based on a context of the identified reference in accordance with a predetermined analysis rule; and
generating an output based on a result of the analysis.

15. The computer program product of claim 14, further comprising an operation for generating a data structure comprising the message file and an associated message identifier.

16. The computer program product of claim 14, wherein the operation for analyzing the source code file and message file is conducted in response to:
at least one of a file context, a component context, and an object context associated with the identified reference; and
at least one rule selected from the group of rules comprising an unreferenced message elimination rule, a duplicate message elimination rule, a context-sensitive message organization rule, a comment generation rule, a message reference update rule, a message consolidation rule, a message consistency rule, a message grammar error detection rule, a message organization error detection rule, an illegal wording detection rule, a phantom message detection rule, and a statistic determination rule.

17. The computer program product of claim 14, further comprising an operation for recording auxiliary information for the identified reference, the auxiliary information comprising at least one of:
a name of the source code file in which the identified reference was identified;
a line number corresponding to the location of the identified reference within the source code file;
a component identifier for identifying an application component with which the identified reference is associated; and
an object type of an insert parameter associated with the identified reference.

18. The computer program product of claim 17, further comprising an operation for generating an analysis log in response to the result of the analysis, the analysis log comprising at least one of a record of an analysis step, a translation cost statistic, a record of the identified reference, a record of auxiliary information associated with the identified reference, and a message to a user.

19. The computer program product of claim 14, further comprising an operation for generating a filtered message file in response to the result of the analysis.

20. The computer program product of claim 14, further comprising an operation for updating the source code file in response to the result of the analysis.
